(19) United States
(12) Patent Application Publication
(10) Pub. No.: US 2022/0032820 A1
(43) Pub. Date: Feb. 3, 2022

(54) Modular Smart Controller for Electric Motor

(71) Applicant: Robert Bosch GmbH, Stuttgart (DE)

(72) Inventors: Kevin Orava, Shelby Township, MI (US); George Marutz, Huntington Woods, MI (US); Luis Angel Ramirez Ortiz, Toluca (MX)

(21) Appl. No.: 16/943,462

(22) Filed: Jul. 30, 2020

(51) Int. Cl. B60N 2/02; H02K 5/22; H02K 11/35; B60R 16/023; B60R 16/037

(52) U.S. Cl. CPC B60N 2/0248; H02K 5/225; H02K 11/35; H02K 2213/12; B60R 16/023; B60R 16/037; B60N 2/0232

(57) ABSTRACT

A modular smart motor assembly comprising a controller and electric motor. The modular smart motor assembly is part of a smart motor system within a vehicle, and operable to adjust configurable elements of the interior of the vehicle. The controller may be detachably coupled to the electric motor, and may be utilized to retrofit existing electric motor systems.

### TECHNICAL FIELD

This disclosure relates to low-wattage electric motors with controllable functions.

### BACKGROUND

Low-wattage electric motors may be utilized in vehicles to make adjustable components of the vehicle's interior. Adjustable interior components may include seats, steering wheels, consoles, pedals, seatbelts, and other interior components that a passenger or driver may wish to arrange in an optimal fashion.

Existing systems may have limited controls or a limited number of motors. It would be desirable to retrofit existing vehicle interiors with adjustable features, resulting in a smart motor system.

### SUMMARY

One aspect of this disclosure rs directed to a smart motor system comprising: a sensor, a controller in first data communication with the sensor, a motor in electrical communication with the controller, and an interface in second data communication with the controller and configured to present system data indicating operating parameters of the smart motor system to a user. The sensor may be operable to generate sensor data indicating at least one parameter measuring an arrangement of a configurable element of a vehicle interior. The motor may be operated by an electrical signal transmitted via the electrical communication between the controller and the motor. The controller is operable to prevent operation of the motor when the at least one parameter indicates that the arrangement of the configurable element is beyond a threshold value and wherein the first data communication comprises a Local Interconnection Network.

A further aspect of this disclosure is directed to a smart motor system comprising: a first motor configured to respond to electrical stimulus and operable to control an arrangement of a first configurable element of a vehicle interior, a second motor configured to respond to electrical stimulus and operable to control an arrangement of a second configurable element of a vehicle interior, a controller in electrical communication with the first motor and the second motor, a first sensor in data communication with the controller and operable to generate first sensor data indicating at least a first parameter measuring the arrangement of the first configurable element, a second sensor in data communication with the controller and operable to generate second sensor data indicating at least a second parameter measuring the arrangement of the second configurable element, and an interface in data communication with the controller and configured to present system data indicating operating parameters of the smart motor system to a user. The controller is operable to prevent operation of the first motor when the first parameter indicates that the arrangement of the first configurable element is beyond a first threshold value, the controller is operable to prevent operation of the second motor when the second parameter indicates that the arrangement of the second configurable element is beyond a second threshold value, and wherein the data communication comprises a Local Interconnection Network.

In some embodiments, the controller may be detachably coupled to the motor. In some embodiments, the Local interconnection Network may comprise a Controller Area Network.

The above aspects of this disclosure and other aspects will be explained in greater detail below with reference to the attached drawings.

### BRIEF DESCRIPTION OF THE DRAWINGS

FIG. 1 is a diagrammatic view of a vehicle interior having a number of modular smart motors.

FIG. 2 is a diagrammatic view of a vehicle console comprising a number of modular smart motors.

FIG. 3 is a diagrammatic view of a vehicle seat having a modular smart motor and control system.

FIG. 4 is a diagrammatic view of a vehicle seat having a modular smart motor and control system.

FIG. 5 is a diagrammatic view of a vehicle interior having a number of modular smart motors.

FIG. 6 is a side view of a modular smart motor assembly comprising a motor controller and a compatible electric motor.

FIG. 7 is a side view of a modular smart motor assembly.

### DETAILED DESCRIPTION

The illustrated embodiments are disclosed with reference to the drawings. However, it is to be understood that the disclosed embodiments are intended to be merely examples that may he embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

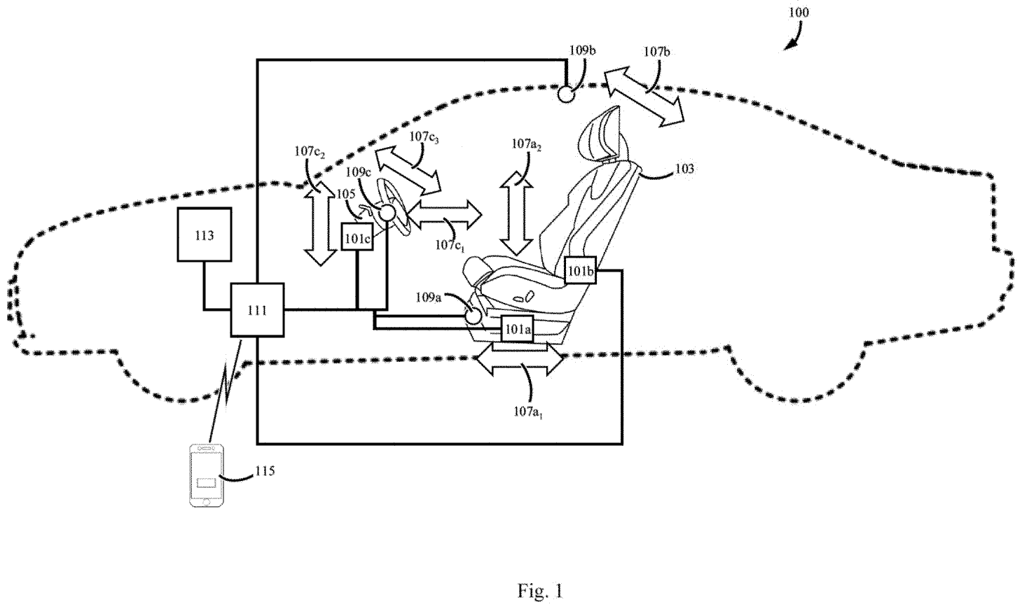

FIG. 1 is a diagrammatic view of a vehicle 100 having an interior. The interior of vehicle 100 may have a number of configurable elements, which may be controlled by one of a number of motor assemblies 101. Each of motor assemblies 101 may comprise an electric motor operable to manipulate at least one associated configurable element and a controller capable providing power to the associated electric motor to control the manipulation. Each controller may further be capable of transmitting and receiving data, such as control data, and generating a corresponding power, signal to operate the associated electric motor in response to the data. In the depicted embodiment the configurable elements may comprise a seat 103 and steering wheel 105, but other configurable elements may comprise a seatbelt, a console, a console panel, driving pedals, a seat stowaway mechanism, a latching mechanism, or any other configurable element known to one of ordinary skill without deviating from the teachings disclosed herein. Although in the depicted embodiment the configurable elements illustrated are related to a driver position within the vehicle 100, other embodiments may comprise additional configurable elements related to passenger positions or storage configurations of the vehicle without deviating from the teachings disclosed. By way of example, and not limitation, additional configurable elements might comprise passenger seats, foldable desks, foldable shelving, folding separators of a storage compartment, a heated seat element, a heated mat element power trunk, or power tailgate, without deviating from the teachings disclosed herein.

Configuration of the configurable elements may occur along at least one adjustable direction 107. A motor assembly 101 may be operable to make adjustments along one or more adjustable directions 107. By way of example, and not limitation, motor assembly 101a may be operable to adjust the leg room of seat 103 by adjusting its displacement along adjustable direction 107a₁, while also being operable to adjust the height of seat 103 by adjusting its displacement along adjustable direction 107a₂. In contrast, motor assembly 101b may only be operable to adjust the relative tilt of seat 103 by adjusting the displacement of the seat-back along adjustable direction 107b. A motor assembly 101 may be operable to control a configurable element along an arbitrary number of adjustable directions 107. For example, motor assembly 101c may be operable to adjust the relative position of steering wheel 105 in at least three adjustable directions. Steering wheel 105 may be moved closer to or further from a driver along adjustable direction 107c₁. Steering wheel 105 may be vertically raised or lowered along adjustable direction 107c₂. Steering wheel 105 may be tilted along adjustable direction 107c₃ to optimize its position for the reach of the driver.

In embodiments wherein a single motor assembly 101 may adjust a configurable element in a plurality of ways, the motor assembly 101 may comprise a plurality of motors or a single motor operable to perform multiple functions without deviating from the teachings disclosed herein.

In the depicted embodiment, seat 103 is, shown to be configurable with respect to leg-room along adjustable direction 107a₁, vertical height along adjustable direction 107a₂, and incline along adjustable direction 107b. Seat 103 may comprise other adjustable components without deviating from the teachings disclosed herein. By way of example, and not limitation, seat 103 may comprise the illustrated incline control, leg-room control, and vertical control, but also such controls as a lumbar control, a swivel control, a tilt control, a seat firmness control, a recliner control, and a folding control without deviating from the teachings disclosed herein. Other embodiments may comprise different combinations of controls without deviating from the teachings disclosed herein.

In the depicted embodiment, vehicle 100 may advantageously utilize a number of sensors 109 to generate sensor data measuring an arrangement of one or more configurable elements. The sensors 109 may be in data communication with the controllers of motor assemblies 101 via a Local Interconnection Network (LIN). In the depicted embodiment, the LIN is supported by a LIN hub 111 that provides data communication between devices connected to the LIN, but other embodiments may comprise independent communications between components without deviating from the teachings disclosed herein. In the depicted embodiment, the LIN may comprise a Controller Area Network (CAN) protocol, and LEN hub 111 may comprise a CAN bus. Other embodiments may comprise other configurations without deviating from the teachings disclosed herein.

The sensors 109 may be utilized to provide indications that are of particular use to one or more of motor assemblies 101. Each of sensors 109 may comprise one or more of a distance sensor, a proximity sensor, a force sensor, a tension sensor, a weight sensor, an obstruction sensor, or another sensor type known to one of ordinary Skill in the art. Each of sensors 109 may be configured to provide measurements useful to one or more of motor assemblies 101, such as a distance measurement, proximity measurement, force measurements, tension measurements, weight measurements, object detections, or any other type of measurement blown to one of ordinary skill in the art. The measurements provided by each of sensors 109 may be utilized to indicate parameters of the measured environment. The parameters may comprise distances between elements of the system or objects within the environment the system, force applied by an element of the system, force applied upon an element of the system, tension experienced by an element of the system, weight of objects within the environment of the system, or detection of objects within the environment of the system. In the depicted embodiment, the controller of a motor assembly 101 may be operable to request sensor data from one or more of sensors 109, and generate a corresponding power signal to operate an associated electric motor in response to the received sensor data. By way of example, and not limitation, a controller may monitor a particular measurement of a sensor 109, and discontinue active operation of an associated electric motor if the measurement is beyond a threshold value. Such a threshold value may correspond to a particular arrangement of a configurable element, and may represent a defined Limit in the arrangement for reasons of passenger comfort or safety. Such thresholds may be utilized to improve safety by providing an “anti-pinch” or “anti-trap” function of motor assembly 101, wherein the motor assembly 101 is configured to stop operation in response to a measurement beyond a threshold value indicating the potential for damage to an external object, damage to the motor, or injury to a passenger or user. Sensors that are utilized for the purpose of enabling an anti-pinch or anti-trap function of the motor assembly 101 may be referred to as “anti-pinch sensors” or “anti-trap” sensors.

By way of example, and not limitation, sensor 109a may comprise an obstruction sensor operable to detect proximity of objects in front of seat 103, and motor assembly 101a may monitor the proximity of any object detected by sensor 109a. If the proximity indicated by the sensor data generated by sensor 109a is below a minimum threshold, motor assembly 101a may discontinue providing power to its associated electric motor so as to avoid damage to the system, injury to a passenger, discomfort of the passenger, or damage to the object in proximity. Sensors 109 may be configured to anticipate common use conditions of vehicle 100. By way of example, and not limitation, sensor 109a may be configured to only detect objects that are smaller than a predetermined threshold size, because it is understood that a driver's legs may be in front of seat 103 when seat 103 is occupied by a driver. Alternatively, motor assembly 101a may utilize a hierarchy of thresholds, Wherein the proximity threshold may be defined differently for smaller objects than a larger objects (such as the driver's legs).

Sensors 109 may be disposed within the interior of vehicle 100 advantageously in locations where they are most effective. By way of example, and not limitation, sensor 109b may comprise a proximity sensor disposed within the ceiling of vehicle 100. Such an arrangement may render sensor 109b advantageous to detect when a passenger's head is approaching the ceiling. Motor assemblies 101a and 101b may advantageously utilize such data during vertical or tilt control of seat 103, and may slow or discontinue their operation of their associated electric motors if a passenger's head comes within a threshold proximity of sensor 109b to optimize the comfort and safety of the passenger.

Similarly by way of example, and not of limitation, sensor 109c may comprise a pressure sensor disposed within steeling wheel 105, and may be utilized to detect when steering wheel 105 is arranged in an uncomfortable or potentially unsafe manner. In one such example, motor assembly 101c may utilize sensor data generated by sensor 109c to determine if the proximity of steering wheel 105 is too low vertically along adjustable direction 107c₂. In such an embodiment, Sensor 109c may detect an upward pressure on steering wheel 105, which may correspond to the steering wheel'being adjusted down against the driver's knees during operation of vehicle 100 if the pressure exceeds a threshold value and a threshold duration. Because such an arrangement may result in an unsafe driving condition, motor assembly 101c may adjust steering wheel 105 along one or more of adjustable directions 107c₁, 107c₂, or 107c₃ until the indicated pressure is no longer greater than the threshold value or duration.

Other embodiments may utilize additional or different numbers of sensors having different configurations without deviating from the teachings disclosed herein. In some embodiments, one or more of motor assemblies 101 may utilize data generated from a plurality of sensors 109 to monitor and optimize the arrangement of the configurable elements within vehicle 100. In some embodiments, one or more of motor assemblies 100 may utilize data generated from different ones of sensors 109 based upon a contextual operation of vehicle 100. In some embodiments, one or more of motor assemblies 100 may utilize one or more of sensors 109 in response to one of sensors 109 malfunctioning or indicating erroneous measurements without deviating from the teachings disclosed herein.

In the depicted embodiment, a memory 113 in data communication with LIN hub 111 may store and provide access to threshold values for the controllers of motor assemblies 101, but other embodiments may comprise other configurations without deviating from the teachings disclosed herein. In some embodiments, each controller may comprise its own distinct memory providing the threshold values associated with the arrangement of configurable elements.

In the depicted embodiment, LIN hub 111 may be in wireless data communication with a computing device 115. In the depicted embodiment, computing device 115 comprises a smart phone, but other embodiments may comprise a tablet computer, laptop computer, cloud-based computer, onboard computing device of vehicle 100, or any other similar device blown to one of ordinary skill in the art without deviating from the teachings disclosed herein. In the depicted embodiment, computing device 115 is data communication with LIN hub 111 via a 2-way wireless connection, such as Bluetooth™, Zigby, or WLAN connection, but other embodiments may utilize other connectivity without deviating from the teachings disclosed herein. In some embodiments, computing device 115 may achieve data communication with LIN hub 111 using an Internet or cloud-based data connection, such as a Wi-Fi connection or satellite data connection, without deviating from the teachings disclosed herein. In some embodiments, computing device 115 may achieve data communication with LIN hub 111 via a wired connection such as a Universal Serial Bus (USB) connection, Ethernet connection, Thunderbolt™ connection, or any other suitable wired connection known to one of ordinary skill in the art without deviating from the teachings disclosed herein.

When in data communication with LIN hub 111, computing device 115 may provide an interface for a user to monitor the arrangement of the configurable elements. In the depicted embodiment, the interface of computing device 115 may additionally permit a user to generate commands to control one or more configurable elements of vehicle 100. This control of the arrangement independent of conventional on-board controls of vehicle 100 may advantageously permit a user to make adjustments to the configurable elements without needing to be within vehicle 100. By way of example, and not limitation, if the previous driver of vehicle 100 was significantly shorter than a current user of vehicle 100, the user may not be able to comfortably get into seat 103 without first adjusting its position relative to the steering wheel 105 and the console of the vehicle. Remote access to the configuration via the interface of computing device 115 may advantageously permit a user to adjust the arrangement of the configurable elements to optimize comfort and ease of entry and exit of the vehicle 100. In another non-limiting example, vehicle 100 may be utilized as a ride-share vehicle, and thus be subject to a wide variety of passengers having a wide variety of configuration preferences. Between active passengers, motor assemblies 101 may reset the configurable elements to a “default” arrangement to accommodate a variety of customers. Alternatively, each customer may set up their own set of threshold values corresponding to a preferred configuration of the vehicle, and vehicle 100 may arrange itself into the preferred configuration for the next customer of the ride share. In some embodiments, vehicle 100 may comprise an “easy entry” feature utilizing motor assembly 101a. In such embodiments, seat 103 may be positioned along adjustable direction 107a such that its distance from steering wheel 105 is maximized when a driver is detected to have exited the vehicle. Seat 103 may remain in this position until a driver enters vehicle 100, in order to optimize the ease of entry. After a driver is detected in the seat 103, motor assembly 101a may then reposition seat 103 to a different position of the driver's choosing to optimize comfort while driving. Such embodiments may be particularly advantageous for ride-share vehicles, which may have a wide variety of drivers having different heights or difficulties entering or exiting the vehicle. Other embodiments may utilize an “easy entry” adjustment for other seats or configurations, without deviating from the teachings disclosed herein.

In the depicted embodiment, users may create and store one Or more user-selectable threshold values that correspond to a user-defined “preset” arrangement of a configurable element. Such user-defined preset arrangements may be utilized to optimize the comfort of a passenger during operation of vehicle 100. In the depicted embodiment, a user may define a plurality of user-defined present arrangements for one or more of the configurable elements of vehicle 100. By way of example, and not limitation, a passenger who is not driving may define a preset arrangement that corresponds to their optimal comfort for reading during the ride, and another preset arrangement corresponding to their optimal comfort for sleeping. Other arrangements may be stored and accessed by users without deviating from the teachings disclosed herein. User-defined preset arrangements may be stored in memory 113, a memory associated with computing device 115, or another memory accessible to LIN huh 111, such as a cloud storage memory accessible via an Internet connection.

In the depicted embodiment, a user may utilize the interface of computing device 115 to directly control one or more of the configurable elements of vehicle 100. In some embodiments, interface control of the configurable elements may override a predetermined threshold. In some embodiments, interface control of the configurable elements may not override a predetermined threshold, such as a threshold that was defined for reasons related to safety. In the depicted embodiment, some threshold defined based on user comfort may be overridden by interface control or user-defined preset, whereas other thresholds defined based upon safety may not be overridden by the user. Other embodiments may comprise other configurations without deviating from the teachings disclosed herein.

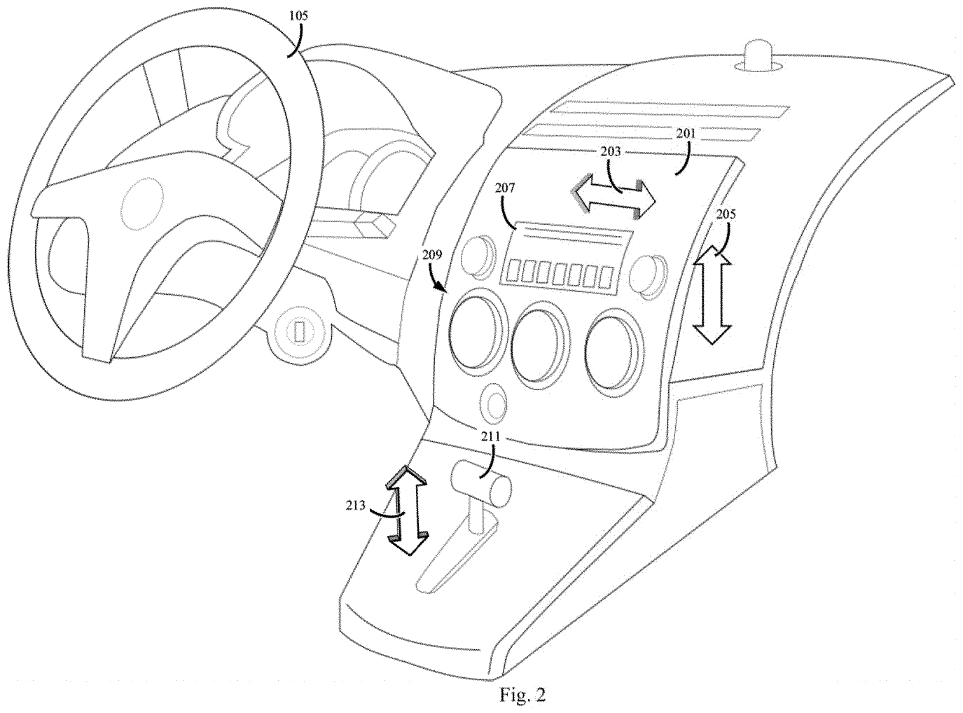

Vehicle 100 may comprise additional configurable elements without deviating from the teachings disclosed herein. FIG. 2 is an illustration of a console having configurable elements that may be adjusted utilizing a smart motor assembly, such as motor assemblies 101 (see FIG. 1). In the depicted embodiment, steering wheel 105 may be adjustable in the same manner as depicted above with respect to FIG. 1, but other elements of the console, may be configurable. In the depicted embodiment, dashboard 201 may be adjusted with respect to its proximity to passengers along adjustable direction 203, and also adjusted with respect to its vertical orientation along adjustable direction 205. Dashboard 201 may additionally provide a supplemental interface 207 similar to the interface provided by computing device 115 (see FIG. 1). Interface 207 may comprise a touchscreen device, or may comprise a number of external controls 209. The arrangement of dashboard 201 may be optimized for user comfort, and controlled by motor assemblies, such as motor assemblies 101 (not shown; see FIG. 1). In the depicted embodiment, other components of the console may be adjustable, such as gear shifter 211, the height of which may be adjusted along adjustable direction 213 in order to optimize the comfort of the driver.

In the depicted embodiment, the associated motor assemblies are not shown, as they are advantageously disposed within the console of the vehicle, away from view of the passengers. Such an arrangement may be advantageous because it optimizes the space available for interface 207 and controls 209 to provide functionality to the user. In the depicted embodiment, interface 207 and controls 209 may provide additional vehicle functionality to the user, such as interior climate control or multimedia access, without deviating from the teachings disclosed herein.

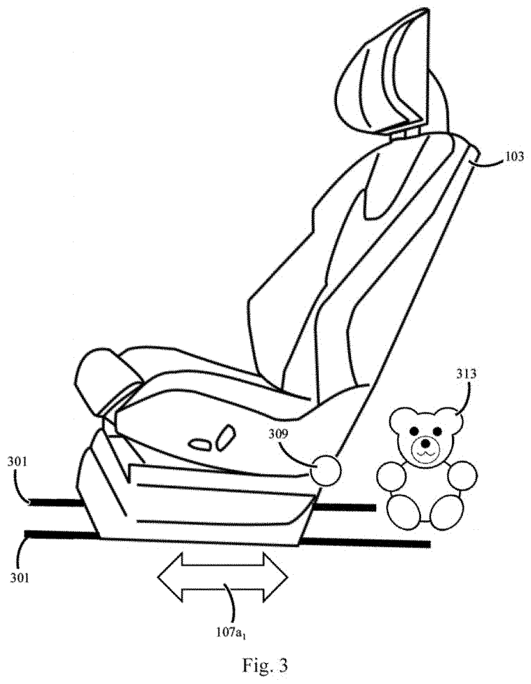

FIG. 3 is a diagrammatic view of the operation of seat 103. In the depicted embodiment, seat 103 is moving along adjustable direction 107a₁, utilizing rails 301. The rails engage with a motor assembly (not shown see FIG. 1) in order to provide motion. A sensor 309 comprises an obstruction sensor, operable to measure the presence of foreign objects on rails 301, such as a toy 313. If seat 103 moves within a threshold proximity of toy 313, the associated motor assembly can stop motion in order to advantageously avoid damage to its electric motor components, rails 301, or toy 313. In the depicted embodiment, this function may additionally advantageously prevent injury if the object obstructing rails 301 is person or pet within the vehicle. In the depicted embodiment, sensor 309 is disposed upon the rear of seat 103, but other embodiments may comprise other configurations without deviation from the teachings disclosed herein. In the depicted embodiment, the motor assembly is disposed within seat 103, which advantageously minimizes the number of moving components that are accessible within vehicle, optimizing safety of the electric motor.

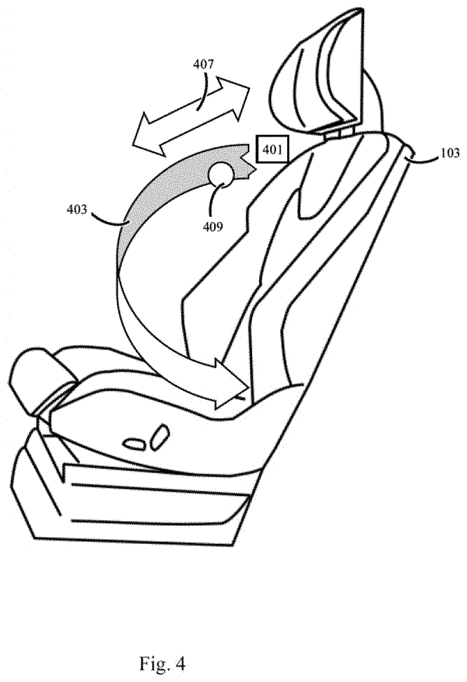

Other embodiments may comprise other sensor types. FIG. 4 is a diagrammatic view a seatbelt adjustment motorized using a motor assembly 401. Motor assembly 401 may be operable to adjust the tension of a seatbelt 403 as it is drawn across the body of a passenger (not shown). Motor assembly 401 may rely upon data generated by a tension sensor 409 to measure the tension of the seatbelt along direction 407. If the tension of the seatbelt is greater than a threshold value, the controller of motor assembly 401 may adjust the tension for the comfort of the safety of the user. In the depicted embodiment, the tension adjustment may be context sensitive with respect to the sensor data generated by tension sensor 401. By way of example, and not Limitation, a very sudden large increase in tension may indicate that the vehicle is experiencing a braking maneuver, and the tension may be maintained or increased for the benefit of the passenger's safety. In contrast, a series of sudden by small increases in tension that quickly subside may indicate a user fidgeting with the seat belt for reasons of comfort, and the tension may be relaxed to optimize the passenger's comfort.

FIG. 4 depicts motor assembly 401, but in some embodiments motor assembly 401 may be disposed behind a console, panel, or other structural component of the interior of the vehicle. Disposing the motor assembly behind a structural component of the interior of the vehicle may advantageously improve the safe operation of the electric motor associated with motor assembly 401 by minimizing passenger interaction and foreign object interference with the electric motor.

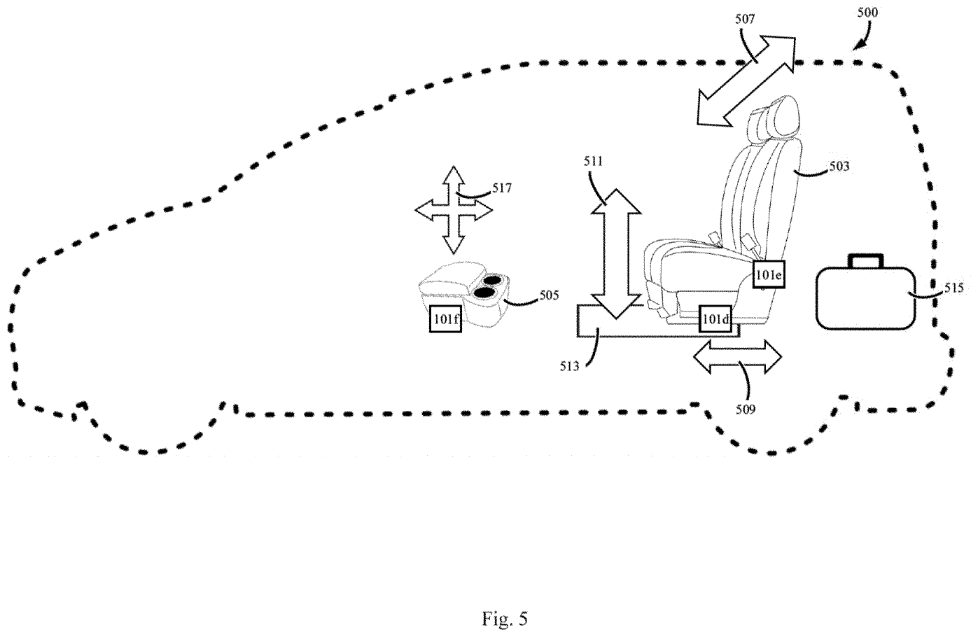

FIG. 5 is a diagrammatic view of an alternate embodiment for the motor system described above with respect to FIG. 1, featuring a vehicle 500 having a number of configurable elements, such as a seat 503, and a passenger console 505. In the depicted embodiment, vehicle 500 comprises a minivan, but other embodiments may comprise other vehicle types, including those listed above with respect to FIG. 1, without deviating from the teachings disclosed herein. In the depicted embodiment, seat 503 comprises a folding bench seat having a seat stowaway function, but other embodiments may comprise other configurations, including those listed above with respect to FIG. 1, without deviating from the teachings disclosed herein. In the depicted embodiment, console 505 comprises a beverage and storage console, but other embodiments may comprise other console configurations, including those listed above with respect to FIG. 2, without deviating from the teachings disclosed herein. In the depicted embodiment, motor assemblies 101d and 101e are operable to control functions of seat 503. In the depicted embodiment, each of motor assemblies 101 may he in data communication with a controlling device, such as LIN hub 111 (not shown; see FIG. 1) or via a user interface, such as computing device 115 (not shown; see FIG. 1) or interface 207 (not shown; see FIG. 2).

Motor assembly 101d may be operable to control the arrangement of seat 503 with respect to adjustable directions 507. 509, and 511. Adjustable direction 507 may comprise a folding mechanism of seat 503, suitable for configuring seat 503 to optimize storage of items within the cabin of vehicle 500, or for a seat stowaway function. Motor assembly 101d may further adjust the front-to-back position of seat 503 with respect to the cabin of vehicle 500. Motor assembly 101d may further be operable to adjust a vertical position of seat 503, such as to within a storage cavity 513 of vehicle 500, located underneath the floorboards of the vehicle cabin. By utilizing the functions of motor assembly 101d, the vehicle 500 may be configured into a stowaway position, wherein seat 503 is folded and lowered into storage cavity 513. When seat 503 is configured into the stowaway position and stored within storage cavity 513, the storage space for cargo, such as luggage 515, may be maximized within the cabin of vehicle 500. In some embodiments, the configuration of seat 503 may comprise a different number of motor assemblies without deviating from the teachings disclosed herein.

Because seat 503 may be positionable along adjustable direction 507, adjustable direction 509, and adjustable direction 511, it may be advantageous to provide a mechanism to prevent unwanted adjustments from forces not generated by motor assemblies 101. Motor assembly 101e may comprise a motorized latching mechanism operable to prevent undesired adjustment of the position of seat 503. By way of example, and not limitation, motor assembly 101e may operate a latching mechanism when seat 503 is determined not to be placed in a stowaway configuration. When the latch of motor assembly 101e is active by the motor assembly, motion of seat 503 along adjustable direction 509 may be prevented. By way of example, and not limitation, this may be useful when storing cargo such as luggage 515 in the vehicle behind seat 503. In the depicted embodiment, a sudden deceleration of vehicle 500 may cause luggage 515 to push against the back of seat 503 if the inertia of luggage 515 is not overcome by the deceleration of vehicle 500. In such an embodiment, the latch activated by motor assembly 101e may advantageously prevent the motion of seat 503 with respect adjustable direction 509, improving the safety conditions of passengers and preventing unsafe motion of luggage 515. Other embodiments may comprise other latching mechanisms controlled by motor assemblies 101 without deviating from the teachings disclosed herein.

In the depicted embodiment, motor assembly 101f may be operable to adjust the relative position of console 505 with respect to adjustable axes 517. In the depicted embodiment, motor assembly 101f may be operable to adjust the position of console 505 with respect to a vertical and side-to-side direction with respect to seat 503. Other embodiments may comprise other functions of motor assembly 101f, such as opening/closing the storage compartment of console 505 without deviating from the teachings disclosed herein. Some embodiments of console 505 may comprise a different number of motor assemblies 101 without deviating from the teachings disclosed herein.

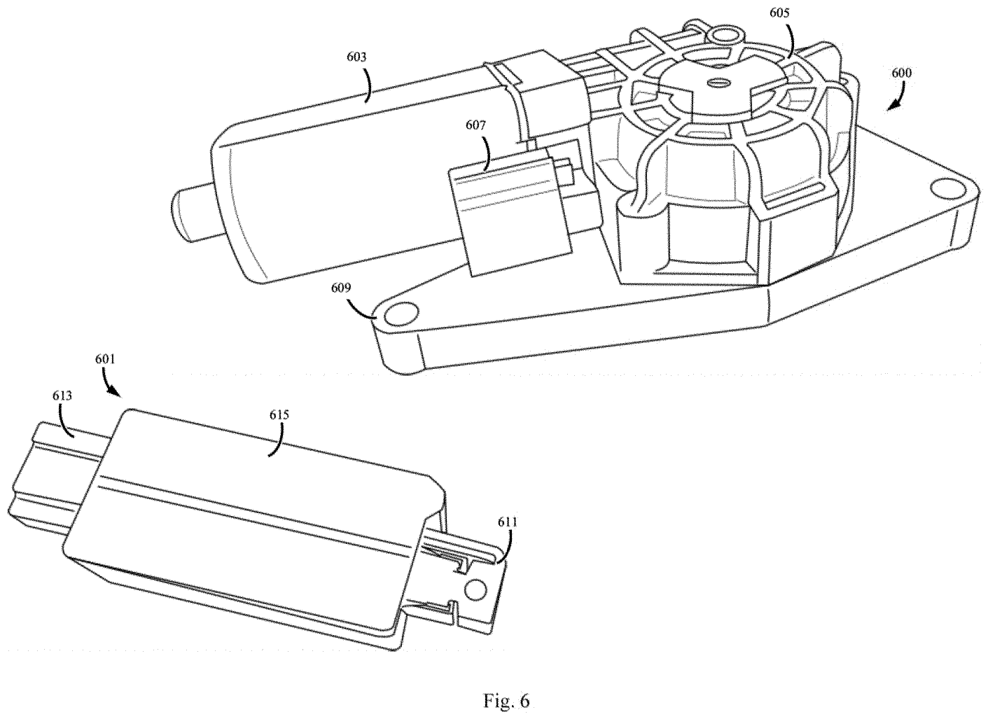

FIG. 6 depicts the components of a motor assembly, such as motor assembly 101 (see FIG. 1). In the depicted embodiment, the motor assembly comprises two primary components: an electric motor 600, and a controller 601. The electric motor comprises an actuator 603 driven by a gear (not shown) housed within a gear housing 605 powered by an electrical signal received via electrical connector 607. Electric motor 600 may additionally be mounted to a structure of the vehicle using a mounting plate 609. In conventional environments, power is generated according to instructions generated by a body controller. In such embodiments, the body controller may comprise processor in electrical communication with a LIN, such as LIN hub 111 (see FIG. 1). In the depicted embodiment, controller 601 is configured to act as a go-between between the conventional power supply of the vehicle and electric motor 600 by interfacing directly with the electric motor 600 via a detachable electrical connection. The interface is accomplished utilizing an output connector 611 that is configured to be received by electrical connector 607. In the depicted embodiment, output connector 611 comprises a multi-pin latching connector, but other embodiments may comprise other configurations without deviating from the teachings disclosed herein. In the depicted embodiment, output connector 611 may comprise an overmolded female connector, which may advantageously permit customizable dimensions compatible with a variety of connector types. By way of example, and not limitation, output connector 611 may comprise an overmolded female connector that is functionally compatible with a variety of electrical inputs found in electric drives, such as electrical connector 607. Output connector 611 may be compatible with a number of standard connectors, conventional connectors, or proprietary connectors in addition to electrical connector 607 without deviating from the teachings disclosed herein.

Controller 601 itself receives power and data via its input connector 613. Input connector 613 may be configured to receive power and data from a LIN. The data may comprise sensor data from a sensor, control data from a processor in data communication with the communication data. Other configurations may utilize other data transmission through input connector 613 without deviating from the teachings disclosed herein. Controller 601 further comprises a chassis 615 housing controller processors (not shown) that are utilized to modulate the electrical signal output via output connector 611. In some embodiments, chassis 615 may comprise a memory without deviating from the teachings disclosed herein. In some embodiments, chassis 615 may comprise a wireless transmitter, wireless receiver, or wireless transceiver operable to provide wireless data communication between controller 601 and one or more external devices, such as LIN hub, without deviating from the teachings disclosed herein.

Controller 601 advantageously comprises a low-profile design suitable for direct coupling to electric motor 600, but other embodiments may utilize an adapter or connector cable without deviating from the teachings disclosed herein. Direct coupling of controller 601 to electric motor 600 may advantageously permit the coupled motor assembly to be housed together within the vehicle, such as within a seat, console, or behind a panel. The direct coupling of controller 601 to electric motor 600 may additionally improve the electromagnetic compliance (EMC) of the device by minimizing the length of the electrical leads coupling the two. Minimizing the length of the electrical leads coupling controller 601 and electric motor 600 may optimize the EMC of the system by minimizing portions of the system susceptible to electromagnetic interference (EMT) from environmental or other external sources.

In some embodiments, output connector 611 and input connector 613 may comprise conventional connectors that are suitable to be inserted into existing vehicle electrical connections. Such implementations may advantageously permit vehicles with existing conventional electric motors to be retrofitted with the functions of controller 601, such as automated control and user control described above with respect to FIG. 1. In this manner, electric motors such as electric motor 600 may effectively be retrofitted to become modular smart motors via controller 601. Advantageously, both output connector 611 and input connector 613 may be detachably connected. Thus, the coupling may be reversed to restore a vehicle to its original configuration or permit for replacement, repair, or upgrade of controller components. Other embodiments may comprise other configurations without deviating from the teachings disclosed herein.

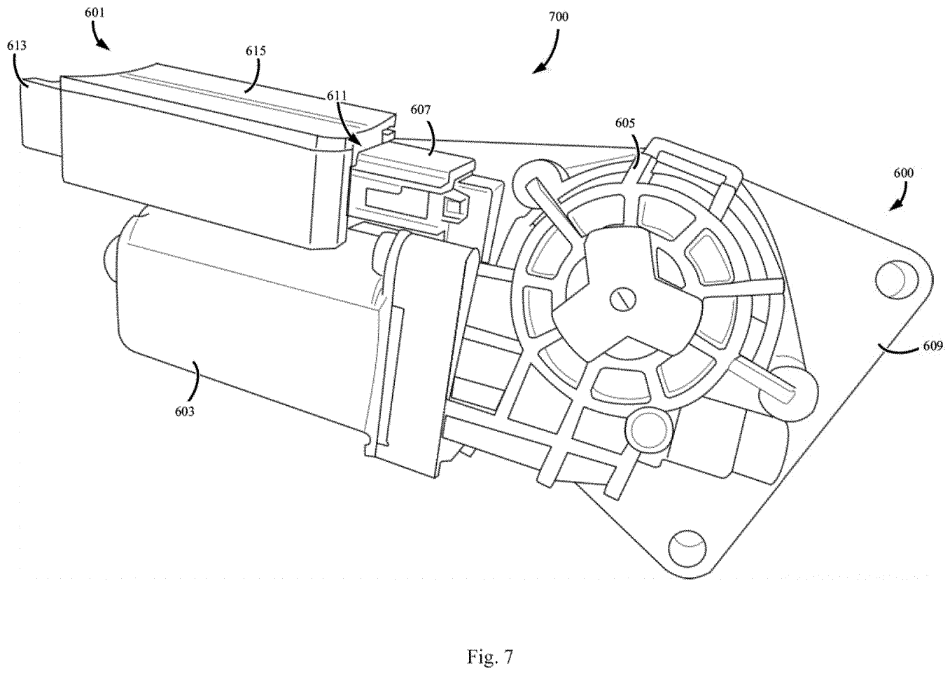

FIG. 7 depicts the motor assembly components of FIG. 6 when coupled for installation. Notably, output connector 613 has been received by electrical connector 607 and is no longer directly visible. In this coupled configuration, a combined motor assembly 700 may be ready for installation within a vehicle. In the depicted embodiment, the coupling is achieved by the latching mechanism of electrical connector 607 and output connector 611, but other configurations may rely upon other physical, mechanisms to stabilize the coupling. By way of example, and not limitation, some embodiments may utilize additional fasteners between electric motor 600 and controller 601. In some embodiments, chassis 615 may comprise its own distinct mounting plate, bracket, or flange to help immobilize controller 601 with respect to electric motor 600 when installed.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed:

1. A smart motor system comprising:
a sensor operable to generate sensor data indicating at least one parameter measuring an arrangement of a configurable element of a vehicle interior:
a controller in first data communication with the sensor;
a motor in electrical communication with the controller, the motor operated by an electrical signal transmitted via the electrical communication; and
an interface in second data communication with the controller and configured to present system data indicating operating parameters of the smart motor system to a user,
wherein the controller is operable to prevent operation of the motor when the at least one parameter indicates that the arrangement of the configurable element is beyond a threshold value and wherein the first data communication comprises a Local Interconnection Network (LIN).

2. The smart motor system of claim 1, wherein the LIN comprises a Controller Area Network (CAN) protocol.

3. The smart motor system of claim 1, wherein the electrical communication between the motor and the controller comprises a detachable electrical connection utilizing an overmolded female connector.

4. The smart motor system of claim 1, wherein the configurable element comprises a seat having adjustable components, the adjustable components comprising at least two of an incline control, a lumbar control, a vertical control, a tilt control, a swivel control, a latching mechanism, a seat stowaway mechanism, a heated seat element, and a leg-room control.

5. The smart motor system of claim 4, wherein the adjustable components comprise an incline control, a lumbar control, a vertical control, a tilt control, a swivel control, a latching mechanism, a seat stowaway mechanism, a heated seat elements and a leg-room control.

6. The smart motor system of claim 1, wherein the sensor is a proximity sensor, the sensor data indicates the proximity of a configurable element to an object, and the parameter is a distance measurement.

7. The smart motor system of claim 1, wherein the sensor is a tension sensor, the sensor data indicates the tension of a seatbelt, and the parameter is a tension measurement.

8. The smart motor system of claim 1, wherein the sensor is an anti-pinch sensor, the sensor data indicates a force exerted upon the configurable element, and the parameter is a force measurement.

9. The smart motor system of claim 1, wherein the sensor is an obstruction sensor, the sensor data indicates a proximity of an object to a configurable element or to the motor, and the parameter is a distance measurement.

10. The smart motor system of claim 1, wherein the controller is further operable to prevent operation of the motor to a command generated by the interface and transmitted to the controller.

11. The smart motor system of claim 1, further comprising a memory in third data communication with the controller, the memory comprising a plurality of threshold values, each of the plurality of threshold values corresponding to a preset arrangement of the configurable element, the controller utilizing one of the plurality of threshold values in response to a command generated by the interface.

12. The smart motor system of claim 11, wherein the controller is operable to write a user-selectable threshold value to the memory, the user-selectable threshold values corresponding to a user-defined preset arrangement of the configurable element.

13. A smart motor system comprising:
a first motor configured to respond to electrical stimulus and operable to control an arrangement of a first configurable element of a vehicle interior;
a second motor configured to respond to electrical stimulus and operable to control an arrangement of a second configurable element of a vehicle interior;
a controller in electrical communication with the first motor and the second motor;
a first sensor in data communication with the controller and operable to generate first sensor data indicating at least a first parameter measuring the arrangement of the first configurable element;
a second sensor in data communication with the controller and operable to generate second sensor data indicating at least a second parameter measuring the arrangement of the second configurable element; and
an interface in data communication with the controller and configured to present system data indicating operating parameters of the smart motor system to a user,
wherein the controller is operable to prevent operation of the first motor when the first parameter indicates that the arrangement of the first configurable element is beyond a first threshold value, the controller is operable to prevent operation of the second motor when the second parameter indicates that the arrangement of the second configurable element is beyond a second threshold value, and wherein the data communication comprises a Local Interconnection Network (LIN).

14. The smart motor system of claim 13, wherein the UN comprises a Controller Area Network (CAN) protocol.

15. The smart motor of claim 13, wherein the electrical communication between the controller and the first motor comprises a detachable electrical connection utilizing an overmolded female connector.

16. The smart motor system of claim 13, wherein the controller is operable to operate the first motor in response to a command received from the interface.

17. The smart motor system of claim 16, wherein the controller is operable to operate the second motor in response to a command received from the interface.

18. The smart motor system of claim 16, wherein the first motor is at least partially disposed within a seat of a vehicle interior and the second motor is at least partially disposed within a console of the vehicle interior.

19. The smart motor of him 13, wherein the controller is operable to prevent operation of the first motor when the second parameter indicates that the arrangement of the second configurable element is beyond a third threshold value.

20. The smart motor of claim 19, wherein the controller is operable to prevent operation of the second motor when the first parameter indicates that the arrangement of the first configurable element is beyond a fourth threshold.
